(19) United States
(12) Patent Application Publication
(10) Pub. No.: US 2026/0178439 A1
(43) Pub. Date: Jun. 25, 2026

(54) MEMORY SYSTEM REPAIR OPERATIONS

(71) Applicant: Micron Technology, Inc., Boise, ID (US)

(72) Inventors: Rishabh DUBEY, Agrate Brianza (IT); Antonino CAPRI', Bergamo (IT); Daniele BALLUCHI, Cernusco Sul Naviglio (IT)

(21) Appl. No.: 19/366,200

(22) Filed: Oct. 22, 2025

Related U.S. Application Data
(60) Provisional application No. 63/736,463, filed on Dec. 19, 2024.

(51) Int. Cl. G06F 11/10

(52) U.S. Cl. CPC G06F 11/1016

(57) ABSTRACT

Implementations herein relate to memory system repair operations. In some implementations, the memory system may include a memory bank, remapping circuitry, and a nonvolatile memory array. The memory bank may include a set of rows (e.g., that are addressable by a host system) and one or more spare rows that are configured to replace defective rows by performing repair operations on the defective rows. The remapping circuitry may be configured to update a mapping of addresses from defective rows to the spare rows, and the nonvolatile memory array may be configured to store physical addresses of the defective rows based on performing repair operations on the defective rows. In some cases, the memory system may identify the spare rows and the updated mapping of the addresses during an initialization operation of the memory system based on the nonvolatile memory array storing the physical addresses of the defective rows.

### CROSS-REFERENCE TO RELATED APPLICATION

This Patent Application claims priority to U.S. Provisional Patent Application No. 63/736,463, filed on Dec. 19, 2024, entitled “MEMORY SYSTEM REPAIR OPERATIONS,” and assigned to the assignee hereof. The disclosure of the prior Application is considered part of and is incorporated by reference into this Patent Application.

### TECHNICAL FIELD

The present disclosure generally relates to a memory system and, for example, memory system repair operations.

### BACKGROUND

Memory devices are widely used to store information in various electronic devices. A memory device includes memory cells. A memory cell is an electronic circuit capable of being programmed to a data state of two or more data states. For example, a memory cell may be programmed to a data state that represents a single binary value, often denoted by a binary “1” or a binary “0 .” As another example, a memory cell may be programmed to a data state that represents a fractional value (e.g., 0.5, 1.5, or the like). To store information, an electronic device may write to, or program, a set of memory cells. To access the stored information, the electronic device may read, or sense, the stored state from the set of memory cells.

Various types of memory devices exist, including random access memory (RAM), read only memory (ROM), dynamic RAM (DRAM), static RAM (SRAM), synchronous dynamic RAM (SDRAM), ferroelectric RAM (FeRAM), magnetic RAM (MRAM), resistive RAM (RRAM), holographic RAM (HRAM), flash memory (e.g., NAND memory and NOR memory), and others. A memory device may be volatile or non-volatile. Non-volatile memory (e.g., flash memory) can store data for extended periods of time even in the absence of an external power source. Volatile memory (e.g., DRAM) may lose stored data over time unless the volatile memory is refreshed by a power source. In some examples, a memory device may be associated with a compute express link (CXL) protocol and/or a CXL compliant memory system.

### BRIEF DESCRIPTION OF THE DRAWINGS

FIGS. 1 and 2 are diagrams illustrating example systems capable of memory system repair operations.

FIG. 3 is a diagram illustrating an example memory system capable of performing memory system repair operations.

FIG. 4 is a diagram illustrating an example of the remapping circuitry capable of performing memory system repair operations.

FIGS. 5 through 10 are flowcharts of example methods associated with memory system repair operations.

### DETAILED DESCRIPTION

Memory systems may employ memory repair operations to maintain the reliability of data stored by the memory system. However, some repair operations may be predominantly hardware-implemented, afford limited configurability, and restrict their adaptability to varying device architectures or operational parameters. For example, some repair operations may not persist across power cycles, may fail to retain data through the execution of the repair operation, may be subject to hardware limitations of the memory system (such as limited resources necessary to complete the repair operation), and/or may not be executable while the memory system is in a mission mode (e.g., while the memory system is receiving and/or executing access commands). Such limitations of the memory repair operations may have repercussions on both the performance and the resiliency of memory systems, specifically in the face of device failures and subsequent data center downtime.

Some implementations described herein relate to memory repair operations that persist across power cycles, retain data integrity during repairs, enable continuous memory operation in a mission mode, and offer configurable repair strategies. For example, a memory system may include a set of memory banks that each include a first set of rows (e.g., that are addressable by a host system) and a second set of spare rows that are configured to replace any defective rows in the first set. The memory system may additionally include remapping circuitry that dynamically updates the mapping of addresses from defective rows to spare rows. The memory system may store the physical addresses of the defective rows in a nonvolatile memory array, which may enable the memory repair operations to persist across power cycles.

Further, the memory system may incorporate a buffer for seamless data migration from the defective row to the spare row during the memory repair operations. In particular, the memory system may store data from the defective row in the buffer during the memory repair operation, which may retain the data from the defective row and enable the memory system to execute access operations associated with the address of the defective row (e.g., at the buffer) during the repair operation.

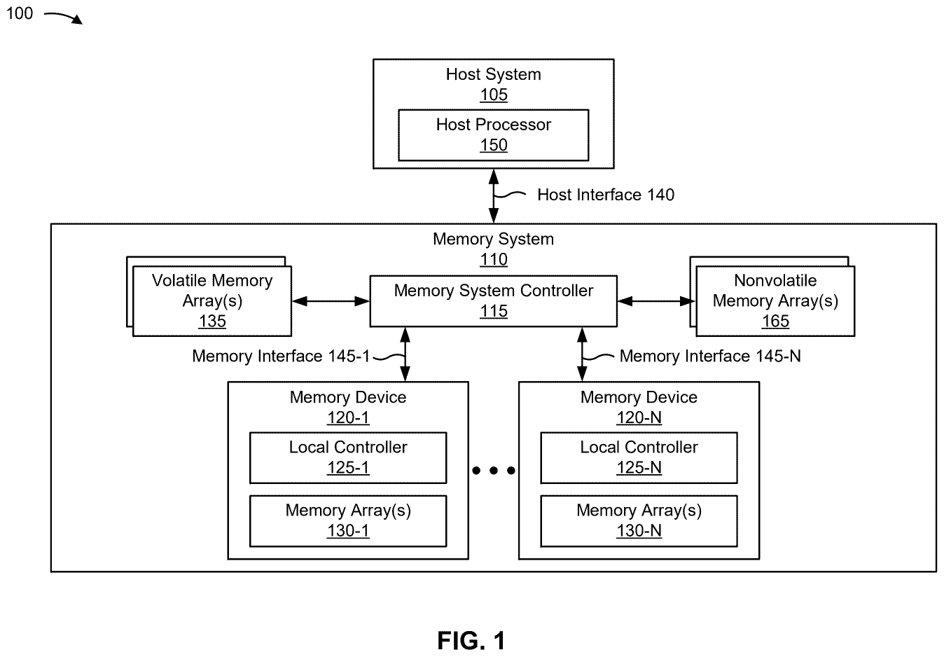

FIG. 1 is a diagram illustrating an example system 100 capable of memory system repair operations. The system 100 may include one or more devices, apparatuses, and/or components for performing operations described herein. For example, the system 100 may include a host system 105 and a memory system 110. The memory system 110 may include a memory system controller 115 and one or more memory devices 120, shown as memory devices 120-1 through 120-N (where N≥1). A memory device may include a local controller 125 and one or more memory arrays 130. The host system 105 may communicate with the memory system 110 (e.g., the memory system controller 115 of the memory system 110) via a host interface 140. The memory system controller 115 and the memory devices 120 may communicate via respective memory interfaces 145, shown as memory interfaces 145-1 through 145-N (where N≥1).

The system 100 may be any electronic device configured to store data in memory. For example, the system 100 may be a computer, a mobile phone, a wired or wireless communication device, a network device, a server, a device in a data center, a device in a cloud computing environment, a vehicle (e.g., an automobile or an airplane), and/or an Internet of Things (IoT) device. The host system 105 may include a host processor 150. The host processor 150 may include one or more processors configured to execute instructions and store data in the memory system 110. For example, the host processor 150 may include a CPU, a graphics processing unit (GPU), a field-programmable gate array (FPGA), an application-specific integrated circuit (ASIC), and/or another type of processing component.

The memory system 110 may be any electronic device or apparatus configured to store data in memory. For example, the memory system 110 may be a hard drive, a solid-state drive (SSD), a flash memory system (e.g., a NAND flash memory system or a NOR flash memory system), a universal serial bus (USB) drive, a memory card (e.g., a secure digital (SD) card), a secondary storage device, a non-volatile memory express (NVMe) device, an embedded multimedia card (eMMC) device, a dual in-line memory module (DIMM), a CXL memory module, and/or a random-access memory (RAM) device, such as a dynamic RAM (DRAM) device or a static RAM (SRAM) device.

The memory system controller 115 may be any device configured to control operations of the memory system 110 and/or operations of the memory devices 120. For example, the memory system controller 115 may include control logic, a memory controller, a system controller, an ASIC, an FPGA, a processor, a microcontroller, and/or one or more processing components. In some implementations, the memory system controller 115 may communicate with the host system 105 and may instruct one or more memory devices 120 regarding memory operations to be performed by those one or more memory devices 120 based on one or more instructions from the host system 105. For example, the memory system controller 115 may provide instructions to a local controller 125 regarding memory operations to be performed by the local controller 125 in connection with a corresponding memory device 120.

A memory device 120 may include a local controller 125 and one or more memory arrays 130. In some implementations, a memory device 120 includes a single memory array 130. In some implementations, each memory device 120 of the memory system 110 may be implemented in a separate semiconductor package or on a separate die that includes a respective local controller 125 and a respective memory array 130 of that memory device 120. The memory system 110 may include multiple memory devices 120.

A local controller 125 may be any device configured to control memory operations of a memory device 120 within which the local controller 125 is included (e.g., and not to control memory operations of other memory devices 120). For example, the local controller 125 may include control logic, a memory controller, a system controller, an ASIC, an FPGA, a processor, a microcontroller, a CXL controller connected to DRAM, and/or one or more processing components. In some implementations, the local controller 125 may communicate with the memory system controller 115 and may control operations performed on a memory array 130 coupled with the local controller 125 based on one or more instructions from the memory system controller 115. As an example, the memory system controller 115 may be an SSD controller, and the local controller 125 may be a NAND controller.

A memory array 130 may include an array of memory cells configured to store data. For example, a memory array 130 may include a non-volatile memory array (e.g., a NAND memory array or a NOR memory array) or a volatile memory array (e.g., an SRAM array or a DRAM array). In some cases, the memory arrays 130 may be organized into one or more memory banks. For example, the memory devices 120 may each include a set of memory banks, that each include one or more of the memory arrays 130.

In some implementations, the memory system 110 may include one or more volatile memory arrays 135. A volatile memory array 135 may include an SRAM array and/or a DRAM array, among other examples. The one or more volatile memory arrays 135 may be included in the memory system controller 115, in one or more memory devices 120, and/or in both the memory system controller 115 and one or more memory devices 120. In some implementations, the memory system 110 may include one or more nonvolatile memory arrays 165. A nonvolatile memory array 165 may include a NOR flash array, a ferroelectric RAM (FeRAM) array, a magnetic RAM (MRAM) array, and/or a resistive RAM (RRAM) array. In some implementations, the memory system 110 may include both nonvolatile memory (e.g., a nonvolatile memory array 165) capable of maintaining stored data after the memory system 110 is powered off, and volatile memory (e.g., a volatile memory array 135) that requires power to maintain stored data and that loses stored data after the memory system 110 is powered off. For example, a volatile memory array 135 may cache data read from or to be written to a nonvolatile memory array 145, and/or may cache instructions to be executed by a controller of the memory system 110.

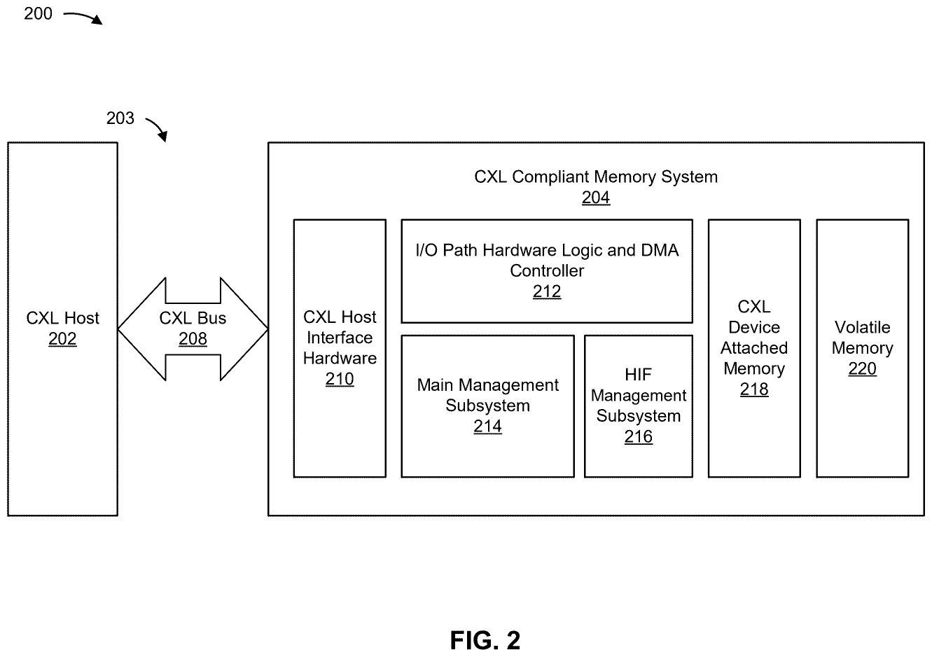

The host interface 140 enables communication between the host system 105 (e.g., the host processor 150) and the memory system 110 (e.g., the memory system controller 115). The host interface 140 may include, for example, a Small Computer System Interface (SCSI), a Serial-Attached SCSI (SAS), a Serial Advanced Technology Attachment (SATA) interface, a Peripheral Component Interconnect Express (PCIe) interface, an NVMe interface, a USB interface, a Universal Flash Storage (UFS) interface, an eMMC interface, a double data rate (DDR) interface, a DIMM interface, and/or a CXL interface (e.g., a PCIe/CXL interface, described in more detail below in connection with FIG. 2).

The memory interface 145 enables communication between the memory system 110 and the memory device 120. The memory interface 145 may include a non-volatile memory interface (e.g., for communicating with non-volatile memory), such as a NAND interface or a NOR interface. Additionally, or alternatively, the memory interface 145 may include a volatile memory interface (e.g., for communicating with volatile memory), such as a DDR interface.

Although the example memory system 110 described above includes a memory system controller 115, in some implementations, the memory system 110 does not include a memory system controller 115. For example, an external controller (e.g., included in the host system 105) and/or one or more local controllers 125 included in one or more corresponding memory devices 120 may perform the operations described herein as being performed by the memory system controller 115. Furthermore, as used herein, a “controller” may refer to the memory system controller 115, a local controller 125, or an external controller. In some implementations, a set of operations described herein as being performed by a controller may be performed by a single controller. For example, the entire set of operations may be performed by a single memory system controller 115, a single local controller 125, or a single external controller. Alternatively, a set of operations described herein as being performed by a controller may be performed by more than one controller. For example, a first subset of the operations may be performed by the memory system controller 115 and a second subset of the operations may be performed by a local controller 125. Furthermore, the term “memory apparatus” may refer to the memory system 110 or a memory device 120, depending on the context.

A controller (e.g., the memory system controller 115, a local controller 125, or an external controller) may control operations performed on memory (e.g., a memory array 130), such as by executing one or more instructions. For example, the memory system 110 and/or a memory device 120 may store one or more instructions in memory as firmware, and the controller may execute those one or more instructions. Additionally, or alternatively, the controller may receive one or more instructions from the host system 105 and/or from the memory system controller 115, and may execute those one or more instructions. In some implementations, a non-transitory computer-readable medium (e.g., volatile memory and/or non-volatile memory) may store a set of instructions (e.g., one or more instructions or code) for execution by the controller. The controller may execute the set of instructions to perform one or more operations or methods described herein. In some implementations, execution of the set of instructions, by the controller, causes the controller, the memory system 110, and/or a memory device 120 to perform one or more operations or methods described herein. In some implementations, hardwired circuitry is used instead of or in combination with the one or more instructions to perform one or more operations or methods described herein. Additionally, or alternatively, the controller may be configured to perform one or more operations or methods described herein. An instruction is sometimes called a “command.”

For example, the controller (e.g., the memory system controller 115, a local controller 125, or an external controller) may transmit signals to and/or receive signals from memory (e.g., one or more memory arrays 130) based on the one or more instructions, such as to transfer data to (e.g., write or program), to transfer data from (e.g., read), to erase, and/or to refresh all or a portion of the memory (e.g., one or more memory cells, pages, sub-blocks, blocks, or planes of the memory). Additionally, or alternatively, the controller may be configured to control access to the memory and/or to provide a translation layer between the host system 105 and the memory (e.g., for mapping addresses to physical addresses of a memory array 130). In some implementations, the controller may translate a host interface command (e.g., a command received from the host system 105) into a memory interface command (e.g., a command for performing an operation on a memory array 130).

Some memory systems 110 may employ memory repair operations to maintain the reliability of data stored by the memory system 110 (e.g., within the memory devices 120). However, some repair operations may be predominantly hardware-implemented, afford limited configurability, and restrict their adaptability to varying device architectures or operational parameters.

For example, the memory system 110 may perform hard Post Package Repairs (hPPRs), which may allow the memory system 110 to perform memory repairs that persist across power cycles. However, the memory system 110 may be unable to perform hPPRs during a mission mode (e.g., during a time period when the memory system is also receiving and/or executing access commands) and hPPRs may not retain data stored in the defective memory cells. Additionally, hPPRs may be associated with a longer execution time, a media reset (e.g., the memory system 110 may perform a media reset during the hPPR), and/or additional complexities such as one or more verification steps.

In another example, the memory system 110 may perform soft Post Package Repairs (sPPRs) or ASIC memory sparing, which may allow the memory system 110 to perform memory repairs during a mission mode while retaining data stored in the defective memory cells. However, sPPRs and ASIC memory sparing may not persist across power cycles. Additionally, hPPRs, sPPRs, and ASIC memory sparing may be associated with hardware limitations. For example, the resources for performing hPPRs and sPPRs may be limited (e.g., the memory system may only have the resources for a limited quantity of hPPRs and/or sPPRs). In another example, the memory system may use an ASIC buffer (e.g., such as an SRAM buffer) for ASIC memory sparing repairs, which may result in an increased SRAM requirement of the memory system 110. Additionally, some memory systems 110 may not support sPPRs (e.g., such as low power double data rate (LP DDR) memory systems 110).

In the example 100, the memory system 110 may include a set of memory banks that each include a first set of rows (e.g., that are addressable by a host system 105) and a second set of spare rows that are configured to replace any defective rows in the first set. The memory system 110 may additionally include remapping circuitry that dynamically updates the mapping of addresses from defective rows to spare rows. The memory system 110 may store the physical addresses of the defective rows present in 135 in a nonvolatile memory array 165, which may enable the memory repair operations to persist across power cycles. Additionally, the memory system 110 may store data from the defective row in a buffer at the memory system 110 during the memory repair operation, which may retain the data from the defective row and enable the memory system 110 to execute access operations associated with the address of the defective row (e.g., at the buffer) during the repair operation.

In some implementations, the memory system 110 of FIG. 1 may include a memory bank, comprising: a plurality of rows, and a spare row configured to replace a defective row from the plurality of rows in the memory bank; remapping circuitry coupled to the memory bank and configured to update a mapping of an address from the defective row to the spare row; and a nonvolatile memory array configured to store a physical address of the defective row based on the remapping circuitry updating the mapping of the address associated with the defective row.

In some implementations, one or more systems, devices, apparatuses, components, and/or controllers of FIG. 1 may be configured to transfer, based at least in part on determining to perform a repair operation on a first row of a memory bank, data from the first row to a buffer at the memory system; remap an address from the first row to a spare row of the memory bank; transfer the data from the buffer to the spare row based at least in part on the remapping; and store, based at least in part on performing the repair operation on the first row, a physical address of the first row in a nonvolatile memory array at the memory system.

In some implementations, one or more systems, devices, apparatuses, components, and/or controllers of FIG. 1 may be configured to transfer, as part of an initialization operation of the memory system, a physical address stored in a nonvolatile memory array at the memory system to a volatile memory array at the memory system, wherein the physical address is of a first row in a memory bank that has been repaired; identify a first spare row in the memory bank that is storing data associated with an address that previously corresponded to the first row; and store, in an address redirector at the memory system, an indication of a remapping of the address from the first row to the first spare row.

In some implementations, one or more systems, devices, apparatuses, components, and/or controllers of FIG. 1 may be configured to receive, from a host system, a command indicating an access operation associated with an address; identify a first physical address of a first row of a memory bank associated with the address; determine whether the address has been remapped from the first physical address to a second physical address of a spare row of the memory bank; and execute the access operation at the first row or the spare row based at least in part on the determining.

The number and arrangement of components shown in FIG. 1 are provided as an example. In practice, there may be additional components, fewer components, different components, or differently arranged components than those shown in FIG. 1. Furthermore, two or more components shown in FIG. 1 may be implemented within a single component, or a single component shown in FIG. 1 may be implemented as multiple, distributed components. Additionally, or alternatively, a set of components (e.g., one or more components) shown in FIG. 1 may perform one or more operations described as being performed by another set of components shown in FIG. 1.

FIG. 2 is a diagram illustrating another example system 200 capable of memory system repair operations. The system 200 may include one or more devices, apparatuses, and/or components for performing operations described herein. In some examples, the system 200 may be associated with a CXL standard and/or protocol (e.g., the system 200 may utilize a CXL protocol to communicate between a host device, sometimes referred to as a CXL compliant host or simply a CXL host, and a memory system, sometimes referred to as a CXL compliant memory system or simply a CXL memory system). In that regard, the system 200 may include a CXL host 202 (which may correspond to the host system 105) and a CXL compliant memory system 204 (which may correspond to the memory system 110). The CXL host 202 and the CXL compliant memory system 204 may communicate via an interface 203 (e.g., host interface 140), which may include a CXL bus 208 (e.g., a PCIe/CXL interface), among other examples.

In some examples, the CXL compliant memory system 204 may be a system that complies with the CXL standard and/or protocol, such as for a purpose of communicating with one or more host devices (e.g., a CXL compliant host, such as CXL host 202). CXL is an open standard that may enable high-speed CPU-to-device and CPU-to-memory interconnects designed to accelerate next-generation performance. The CXL standard may enable memory coherency between the CPU memory space and memory on attached devices, which allows resource sharing for higher performance, reduced software stack complexity, and lower overall system cost. CXL is designed to be an industry open standard for enabling an interface for high-speed communications. CXL technology utilizes the PCIe infrastructure, leveraging PCIe physical and electrical interfaces to provide an advanced protocol in areas such as input/output (I/O) protocol, memory protocol, and coherency interface.

In some examples, the system 200 may include a PCIe/CXL interface (e.g., the CXL bus 208 may be associated with a PCIe/CXL interface), which may be a physical interface configured to connect the CXL compliant memory system 204 to CXL compliant host devices, such as the CXL host 202. In such examples, the PCIe/CXL interface may comply with CXL standard specifications for physical connectivity, ensuring broad compatibility and ease of integration into existing systems using the CXL protocol. Additionally, or alternatively, the CXL compliant memory system 204 may be designed to efficiently interface with computing systems (e.g., CXL host 202 and/or a host system 105) by leveraging the CXL protocol. For example, the CXL compliant memory system 204 may be configured to utilize high-speed, low-latency interconnect capabilities of CXL, such as for a purpose of making the CXL compliant memory system 204 suitable for high-performance computing, data center applications, artificial intelligence (AI) applications, and/or similar applications.

In some examples, the CXL compliant memory system 204 may include a CXL memory system controller (e.g., a CXL ASIC, which may correspond to the memory system controller 115 and/or local controller 125), which may be configured to manage data flow between memory arrays (shown as CXL device attached memory 218, which may correspond to the volatile memory arrays 135 and/or the memory arrays 130) and a CXL interface (e.g., the CXL bus 208). In some examples, the CXL memory system controller may be configured to handle one or more CXL protocol layers, such as an I/O layer (e.g., a layer associated with a CXL. io protocol, which may be used for purposes such as device discovery, configuration, initialization, I/O virtualization, direct memory access (DMA) using non-coherent load-store semantics, and/or similar purposes); a cache coherency layer (e.g., a layer associated with a CXL. cache protocol, which may be used for purposes such as caching host memory using a modified, exclusive, shared, invalid (MESI) coherence protocol, or similar purposes); or a memory protocol layer (e.g., a layer associated with a CXL. memory (sometimes referred to as CXL. mem) protocol, which may enable a CXL memory device to expose host-managed device memory (HDM) to permit a host device to manage and access memory similar to a native DDR connected to the host); among other examples.

The CXL compliant memory system 204 may further include and/or be associated with one or more high-bandwidth memory modules (HBMs) or similar memory arrays (e.g., CXL device attached memory 218). For example, the CXL compliant memory system 204 may include multiple layers of DRAM (e.g., stacked and/or interconnected through advanced through-silicon via (TSV) technology) in order to maximize storage density and/or enhance data transfer speeds between memory layers. Additionally, or alternatively, the CXL compliant memory system 204 (e.g., a CXL ASIC of the CXL compliant memory system 204) may include a power management unit, which may be configured to regulate power consumption associated with the CXL compliant memory system 204 and/or which may be configured to improve energy efficiency for the CXL compliant memory system 204. Additionally, or alternatively, the CXL compliant memory system 204 (e.g., a CXL ASIC of the CXL compliant memory system 204) may include additional components, such as one or more error correction code (ECC) engines, such as for a purpose of detecting and/or correcting data errors to ensure data integrity and/or improve the overall reliability of the CXL compliant memory system 204. The CXL compliant memory system 204 may be implemented using a combination of hardware and firmware blocks and/or components. In such examples, the firmware may execute on one or more embedded CPUs within the CXL compliant memory system 204.

Additionally, or alternatively, the CXL compliant memory system 204 and/or a CXL memory system controller (e.g., a CXL ASIC) of the CXL compliant memory system 204 may include CXL host interface hardware 210, an I/O path hardware logic and DMA controller 212, a main management subsystem 214, and/or a host interface (HIF) management subsystem 216, among other examples. In some examples, the CXL host interface hardware 210 may be hardware components that enable physical connectivity between the CXL compliant memory system 204 and one or more external devices, such as to the CXL host 202 via the CXL bus 208. In some examples, the CXL host interface hardware 210 may include the necessary physical interfaces and protocol logic required to establish and/or maintain communication over the CXL link (e.g., via the CXL bus 208). In some cases, the CXL host interface hardware 210 may ensure that the CXL host 202 can access and/or control the CXL compliant memory system 204 efficiently.

The I/O path hardware logic and DMA controller 212 may handle data transfers between the CXL compliant memory system 204 and external devices, such as other memory modules and/or peripheral components. In some examples, a DMA controller portion of the I/O path hardware logic and DMA controller 212 may permit efficient data transfer without involving a CXL compliant memory system 204 CPU, directly. Put another way, the DMA controller portion of the I/O path hardware logic and DMA controller 212 may manage data movement between the CXL compliant memory system 204 and other system components, which may enhance overall system performance by offloading data transfer tasks from the CPU.

The main management subsystem 214 may serve as a central control and management unit within the CXL compliant memory system 204. In some examples, the main management subsystem 214 may encompass various functionalities and tasks, such as memory access control, error detection and/or correction, power management, and/or similar system management functionalities and/or tasks. Additionally, or alternatively, the main management subsystem 214 may ensure proper functioning and/or reliability of the CXL compliant memory system 204 and/or may optimize the performance of the CXL compliant memory system 204 under various operating conditions.

The HIF management subsystem 216 may be responsible for managing and/or controlling the CXL host interface hardware 210, among other tasks. In some examples, the HIF management subsystem 216 may handle tasks related to link initialization configuration negotiation with the CXL host 202, error handling, and/or other protocol-specific functionalities. Additionally, or alternatively, the HIF management subsystem 216 may ensure smooth communication between the CXL compliant memory system 204 and/or the CXL host 202, such as by maintaining compatibility and/or reliability of the CXL link, among other examples.

In some examples, the CXL compliant memory system 204 may be categorized as a CXL type 1 device, a CXL type 2 device, or a CXL type 3 device. A CXL type 1 device may be a device that implements a coherent cache using the CXL. cache protocol. A CXL type 2 device may be a device that implements both a coherent cache using the CXL. cache protocol and a host-managed device memory using the CXL. mem protocol. For example, a CXL type 2 device may be a hardware accelerator device. A CXL type 3 device may be a device that implements a host-managed device memory using the CXL. mem protocol. For example, a CXL type 3 device may be a memory expander device.

The number and arrangement of components shown in FIG. 2 are provided as an example. In practice, there may be additional components, fewer components, different components, or differently arranged components than those shown in FIG. 2. Furthermore, two or more components shown in FIG. 2 may be implemented within a single component, or a single component shown in FIG. 2 may be implemented as multiple, distributed components. Additionally, or alternatively, a set of components (e.g., one or more components) shown in FIG. 2 may perform one or more operations described as being performed by another set of components shown in FIG. 2.

The CXL compliant memory system 204 may include the volatile memory 220, which may include one or more DRAM devices. The volatile memory 220 may include a set of memory banks that each include a first set of rows (e.g., that are addressable by a CXL host 202) and a second set of spare rows that are configured to replace any defective rows in the first set. The CXL compliant memory system 204 may additionally include remapping circuitry that dynamically updates the mapping of addresses from defective rows to spare rows. The CXL compliant memory system 204 may store the physical addresses of the defective rows in a nonvolatile memory array 165, which may enable the memory repair operations to persist across power cycles. Additionally, the CXL compliant memory system 204 may store data from the defective row in a buffer at the CXL compliant memory system 204 during the memory repair operation, which may retain the data from the defective row and enable the CXL compliant memory system 204 to execute access operations associated with the address of the defective row (e.g., at the buffer) during the repair operation.

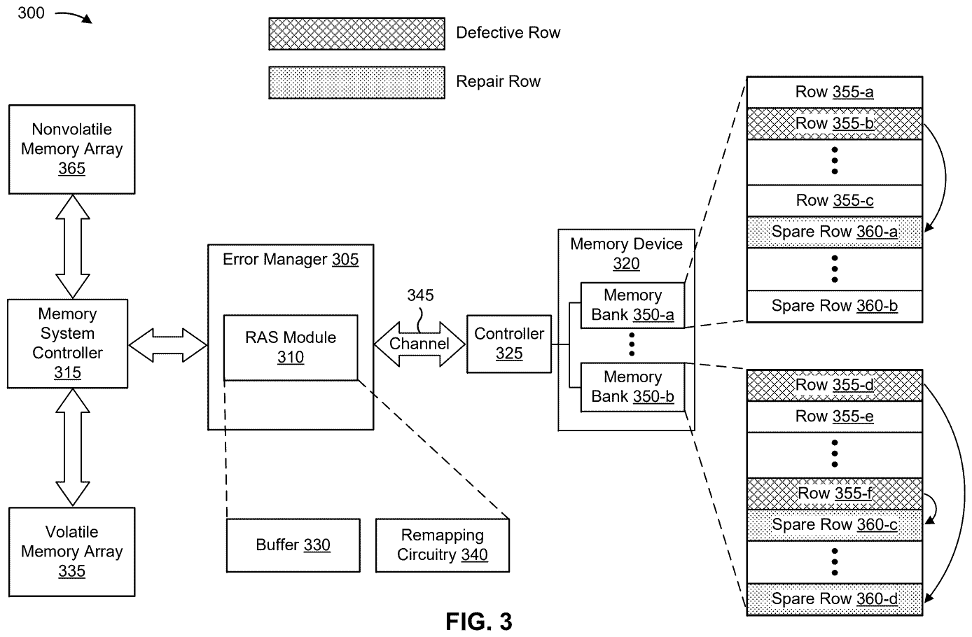

FIG. 3 is a diagram illustrating an example memory system 300 capable of performing memory system repair operations. In some cases, the memory system 300 includes aspects of systems, devices, or components described with reference to FIGS. 1 and 2. For example, the memory system 300 may include aspects of the memory system 110 and the CXL compliant memory system 204.

The memory system 300 may include a memory system controller 315, a volatile memory array 335, and a nonvolatile memory array 365. In some cases, the memory system controller 315 may include aspects of the memory system controller 115 or the CXL memory system controller. Additionally, the volatile memory array 335 and the nonvolatile memory array 365 may include aspects of the volatile memory array(s) 135 and the nonvolatile memory array(s) 145, respectively. The memory system 300 may additionally include one or more memory devices 320, which may include aspects of the memory devices 120 and the CXL attached memory 218. The memory devices 320 may be coupled to a controller 325, and may include a set of memory banks 350. In some cases, the controller 325 may include aspects of the controller 125 and/or the memory system controller 115, and the memory banks 350 may include one or more memory arrays (such as the memory arrays 130).

The memory system 300 may additionally include an error manager 305. In some cases, the error manager 305 may be implemented by the memory system controller 315. For example, the error manager 305 may be implemented by a CXL memory controller. In some cases, the error manager 305 may be implemented using a combination of hardware and firmware blocks and/or components. The error manager 305 may be configured to improve a reliability of data stored by the memory system 300.

The error manager 305 may include one or more reliability, availability, and serviceability (RAS) modules 310. In some cases, the error manager 305 may include a RAS module 310 for each channel 345 of the memory system 300. In such cases, each RAS module 310 may perform operations associated with the reliability, availability, and/or serviceability of the one or more memory devices 320 that are coupled to the channel 345. While FIG. 3 illustrates the channel 345 coupling a single memory device 320 to the error manager 305, the channel 345 may couple more than one memory device 320 to the error manager 305. For example, the memory system 300 may include two rank or four rank memory configuration, and the channel 345 may couple four memory devices 320 to the error manager 305. In another example, the memory system 300 may include two rank memory, and the channel 345 may couple two memory devices 320 to the error manager 305. Additionally, while not illustrated in FIG. 3, the memory system 300 may include additional RAS modules 310 and additional channels 345 (e.g., coupling the error manager 305 to additional memory devices 320). For example, the memory system 300 may include four, eight, eighteen, or some other quantity of channels 345 (and corresponding RAS modules 310 and memory devices 320).

The RAS module 310 may be configured to perform one or more error management operations for the corresponding memory device(s) 320. That is, the RAS module 310 may be configured to perform error management operations for data and/or access operations associated with the memory device 320. In one example, the RAS module 310 may be configured to implement a spare array of independent disks (RAID) scheme to store data at the memory device 320. In another example, the RAS module 310 may perform one or more error detection and/or correction operations on data to be stored on the memory device 320. In another example, the RAS module 310 may implement locked step accesses at the memory device 320. For locked step accesses, the RAS module 310 may execute access operations at two or more separate memory banks 350. For example, the RAS module 310 may execute each write operation at both a first memory bank 350-a and a second memory bank 350-b. Then, the RAS module 310 may perform read operations at both the first memory bank 350-a and the second memory bank 350-b. The RAS module 310 may detect errors within data stored by the first memory bank 350-a and the second memory bank 350-b if the data read from the first memory banks 350-a and the second memory bank 350-b is different.

The memory banks 350 in the memory system 300 may each include a first set of rows 355 and a second set of spare rows. The rows 355 and the spare rows 360 may correspond to rows of memory cells that may be uniquely addressed for accessing data. The first set of rows 355 may be initially configured (such as during a manufacturing process, during a first initialization process) to correspond to an address space that is addressable by a host system (such as the host system 105 or the CXL host 202). The second set of spare rows 360 may correspond to additional physical rows at the memory bank 350 that are not initially configured to be addressable by the host system. The spare rows may also be referred to as “redundant rows” or “repair rows.” In some cases, each memory bank 350 may include the same quantity of spare rows 360. For example, each memory bank 350 may include 16 spare rows 360. In some other cases, each memory bank 350 may have different quantities of spare rows 360.

The RAS module 310 may perform repair operations on the rows 355 that become defective within the memory device 320 or memory devices 320 that are coupled to the channel 345 associated with the RAS module 310. During the repair operation, the RAS module 310 may remap an address associated with the row 355 that is defective in a memory bank 350 to a spare row 360 in the memory bank 350. FIG. 3 illustrates an example where the rows 355-b, 355-d, and 355-f are defective rows and the RAS module 310 remaps the address associated with the row 355-b to the spare row 360-a, the address associated with the row 355-d to the spare row 360-d, and the address associated with the row 355-f to the spare row 360-c. In cases where the error manager 305 performs locked step access operations using two or more memory banks 350, the RAS module 310 may remap the address associated with both the row 355 in the first memory bank 350 that is defective and the corresponding row 355 in the second memory bank 350 that is not defective. That is, the RAS module 310 may perform repair operations on both corresponding rows 355.

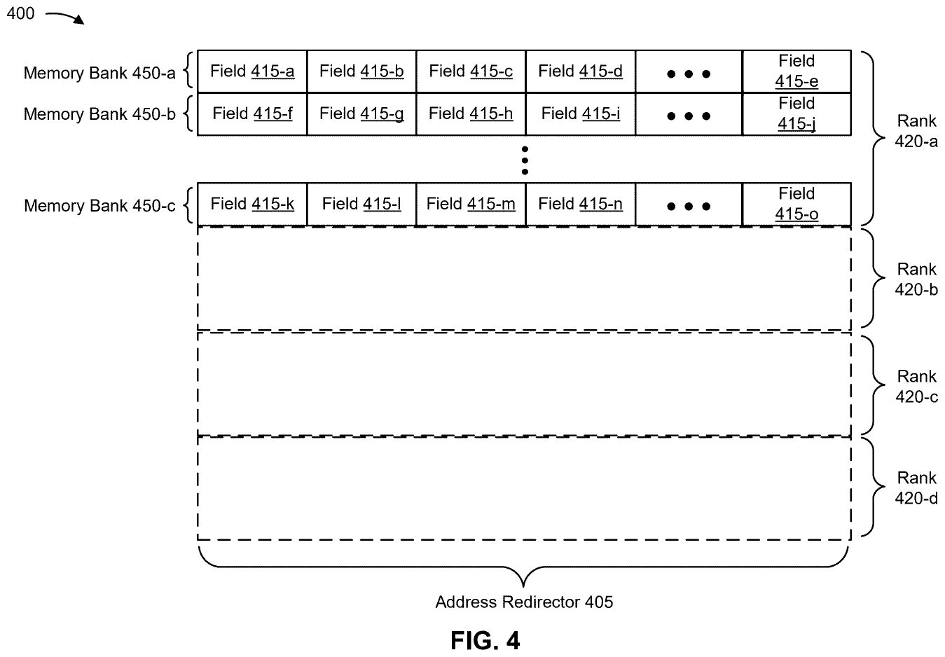

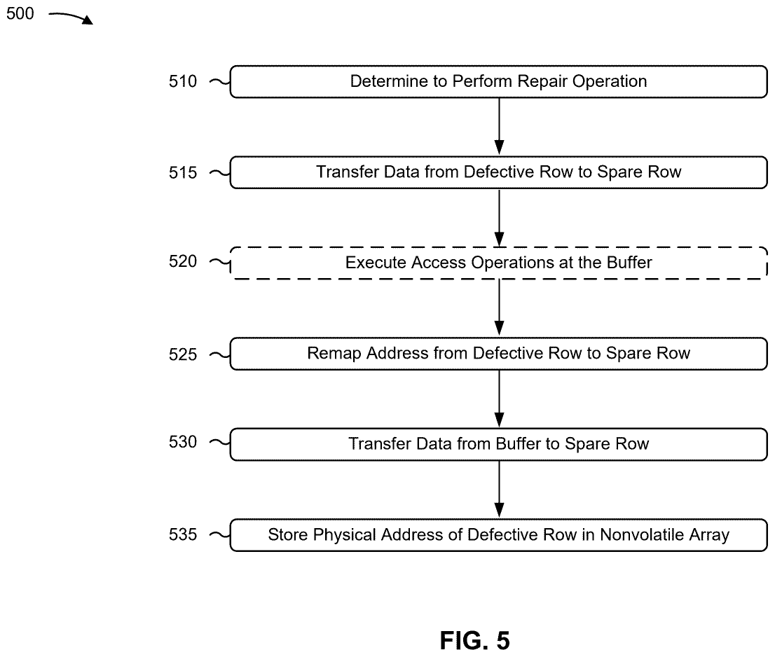

An example method 500 of performing a repair operation on a row 355 that is defective is described with reference to FIG. 5. In particular, the RAS module 310 may include remapping circuitry 340 which may be configured to remap the address associated with the row 355 that is defective to the spare row 360. In some cases, remapping the address may correspond to updating the mapping of the address from the defective row to the spare row 360. An example of the remapping circuitry 340 is described with reference to FIG. 4.

The RAS module 310 may retain the data stored in a row 355 that is defective throughout the repair operation execution. That is, the memory system 300 may be capable of performing a repair operation of a row 355 that is defective without losing data stored in that row 355. Accordingly, the RAS module 310 may retain the data stored in the rows 355-b, 355-d, and 355-f during the repair operations of those rows 355. To retain the data stored in the row 355 that is defective, the RAS module 310 may transfer the data from the row 355 to the buffer 330 prior to remapping the address associated with that row 355 to a spare row 360. After remapping the address to the spare row 360, the RAS module 310 may write the data from the buffer 330 to the spare row 360.

The RAS module 310 may be capable of executing the repair operation while operating in a mission mode. That is, the memory system 300 may execute the repair operation and one or more access operations (e.g., in response to receiving access commands from a host system) during overlapping time periods. Additionally, the memory system 300 may be able to execute the repair operation without power cycling the memory system 300 and without performing a reinitialization of the memory system 300. If the memory system 300 receives or generates an access command indicating an address associated with a row 355 that is defective while performing the repair operation on the row 355 that is defective, the memory system 300 may perform the access operation indicated by the access command at the buffer 330. For example, if the access command indicates a read operation at an address corresponding to the row 355-f while the RAS module 310 is performing a repair operation on the row 355-f, the memory system 300 may read the data from the buffer 330 to execute the read operation. In another example, if the access command indicates a write operation at an address corresponding to the row 355-d while the RAS module 310 is performing a repair operation on the row 355-d, the memory system 300 may write data to the buffer 330 to execute the write operation.

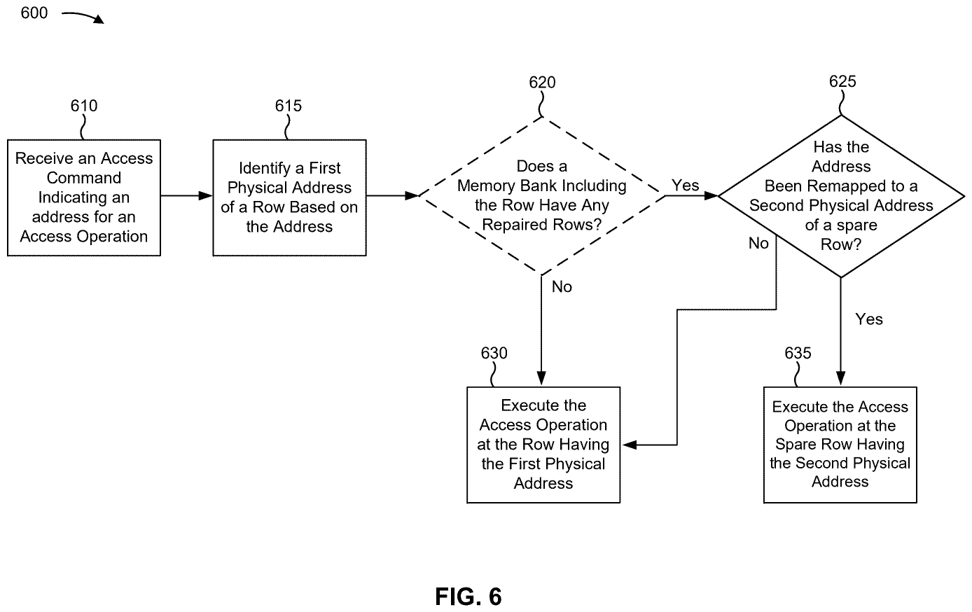

After a repair operation of a row 355 that is defective has been completed to remap an address associated with the row 355 to a spare row 360, the memory system 300 may perform access operations associated with the address at the spare row 360. For example, after the repair operations of the rows 355-b, 355-d, and 355-f have been completed, the memory system 300 may perform access operations at the spare rows 360-a, 360-d, and 360-c, respectively. An example method 600 of performing an access operation at an address that has been remapped from a row 355 that is defective to a spare row 360 is described with reference to FIG. 6.

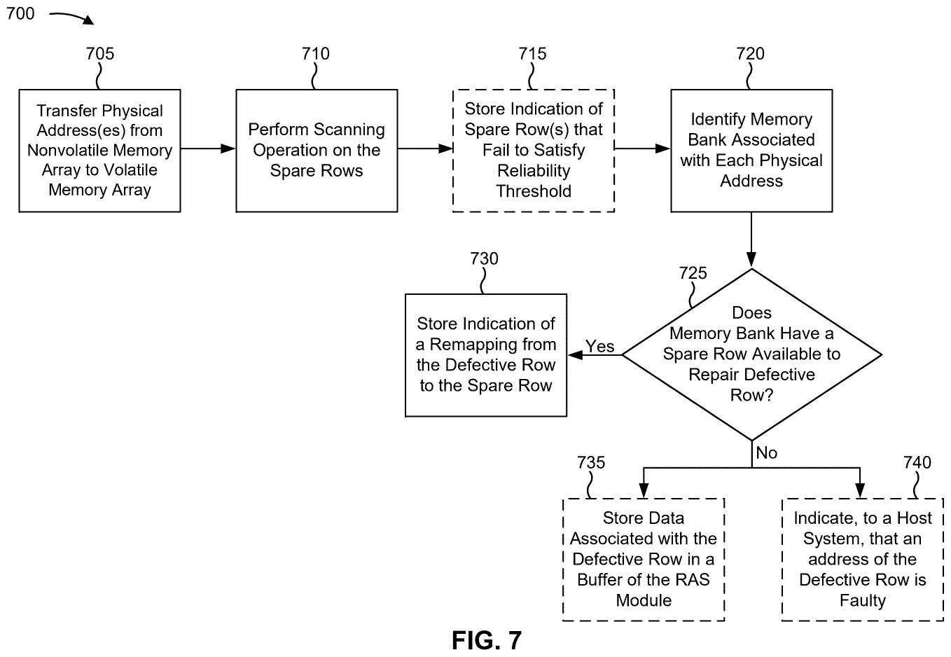

The repair operation of a row 355 that is defective may persist across a power cycle. That is, if a repair operation remaps an address from a row 355 to a spare row 360, the remapping persists even after the memory system 300 is powered off. To enable the repair operation to persist across the power cycle, the RAS module 310 may write a physical address of a row 355 that has been repaired to a nonvolatile memory array 365. For example, the RAS module 310 may write the physical addresses of the rows 355-b, 355-d, and 355-f to the nonvolatile memory array 365 based on the rows 355-b, 355-d, and 355-f being repaired including the spare row 360-a, 360-c, 360-d and the related association. After the memory system 300 is power cycled (e.g., after the memory system 300 is powered off and subsequently powered back on), the memory system 300 may perform an initialization operation, which may include reestablishing the remapping of the address from the row 355 that is defective to the spare row 360 based on the physical address of the row 355 that is defective being stored in the nonvolatile memory array 365. An example method 700 of performing an initialization operation that reestablishes the remapping of the address is described with reference to FIG. 7.

As indicated above, FIG. 3 is provided as an example. Other examples may differ from what is described with regard to FIG. 3.

FIG. 4 is a diagram illustrating an example 400 of the remapping circuitry capable of performing memory system repair operations. In some cases, the example 400 of the remapping circuitry includes aspects of systems, devices, or components described with reference to FIGS. 1 through 3. For example, the remapping circuitry 340 may include aspects of the example 400.

The remapping circuitry may correspond to a hardware block that is included in a last stage of a RAS module (such as the RAS module 310). In the example 400, the remapping circuitry may include an address redirector 405. In some cases, the address redirector 405 may correspond to a cache (e.g., an SRAM cache). In some other cases, the address redirector 405 may include other types of memory (a volatile memory array). The address redirector 405 may include a set of fields 415, which may also be referred to as tags, that are associated with each memory bank 450 and rank 420 of the memory device or memory devices corresponding to that RAS module. For example, the address redirector 405 may include a set of fields 415 including field 415-a, field 415-b, field 415-c, field 415-d, and field 415-e that are associated with the memory bank 450-a and the rank 420-a; a set of fields 415 including field 415-f, field 415-g, field 415-h, field 415-i, and field 415-j that are associated with the memory bank 450-b and the rank 420-a; and a set of fields 415 including field 415-k, field 415-l, field 415-m, field 415-n, and field 415-o may be associated with the memory bank 450-c and the rank 420-a. If the memory system is a rank two memory system, the address redirector 405 may additionally include a set of fields 415 that are associated with each of the banks 450 on the rank 420-b. Additionally, if the memory system is a rank four memory system, the address redirector 405 may additionally include sets of fields that are associated with each of the banks 450 on the rank 450-c and the rank 450-d.

Each set of fields 415 (that are associated with a same memory bank 450 and rank 420) may include a field 415 for each of the spare rows within the memory bank 450. For example, the set of fields 415 that are associated with the memory bank 450-a and the rank 420-a may include a field 415 for each of the spare rows within the memory bank 420-a. That is, the field 415-a may be associated with a first spare row in the memory bank 420-a, the field 415-b may be associated with a second spare row in the memory bank 420-a, the field 415-c may be associated with a third spare row in the memory bank 420-a, the field 415-d may be associated with a fourth spare row in the memory bank 420-a, and the field 415-e may be associated with a fifth spare row in the memory bank 420-a. In some cases, each set of fields 415 may include the same quantity of fields 415 as a quantity of spare rows in the associated memory bank 450-a. For example, if the memory bank 450-b includes 16 spare rows, the address redirector 405 may include 16 fields 415 that are associated with the memory bank 450-b and the rank 420-a.

The RAS module may rely on the remapping circuitry to remap an address associated with a defective row in a memory bank to one of the spare rows in that memory bank. To remap the address associated with the defective row in the memory bank 450, the RAS module may store an indication of the physical address of the defective row in one of the fields 415 associated with the memory bank 450 (and the rank 420 that is associated with the memory bank 450). For example, to remap the address associated with a defective row in the memory bank 450-b, the RAS module may store an indication of the physical address of the defective row in one of the fields 415 associated with the memory bank 450-b (such as in the field 415-f, the field 415-g, the field 415-h, the field 415-i, or the field 415-j).

The RAS module may identify the set of fields 415 in the address redirector 405 for storing the indication of the physical address of the defective row based on the rank 420 and the memory bank 450 of the physical address. For example, the RAS module may identify an offset within the address redirector 405 for storing the indication of the physical address of the defective row based on the rank 420 and the memory bank 450. In a case where the physical address for the defective row is associated with the memory bank 450-c and the rank 420-a, the RAS module may identify an offset within the address redirector that corresponds to the field 415-k through the field 415-o.

The remapping of the address from the defective row to the spare row may be indicated based on the association of each field 415 to a spare row in a memory bank 450. That is, a field 415 that stores an indication of a physical address of a defective row in the memory bank 450 may indicate that the address of the defective row is remapped to the spare row that is associated with that field 415. To perform the remapping of an address associated with a defective row to a spare row, the RAS module may store an indication of the physical address of the defective row in a field 415 of the cache 405 and may identify the spare row for the repair operation of the defective row as the spare row that is associated with the field 415. Then, the RAS module may transfer the data from the buffer (such as the buffer 330) to the spare row that is associated with the field 415.

The remapping circuitry may maintain entries indicative of the defective rows (e.g., the failing rows, the bad rows) and the associated spare rows. Then, a memory system (such as the memory system 300) may use the remapping circuitry to determine an actual row address (e.g., a physical address of the spare row) associated with an address. For example, if an access operation is associated with a physical address of a row (such as a non-spare row) in a memory bank 450, the RAS module may compare the physical address to the indications of physical addresses stored in the set of fields 415 that are associated with the memory bank 450. If the RAS module determines that none of the one or more fields 415 that are associated with that memory bank 450 include an indication of the physical address associated with the access operation, the RAS module may determine that the row indicated by the physical address has not been repaired, and may execute the access operation at the indicated row. Additionally, if the RAS module determines that one of the fields 415 that is associated with the memory bank 450 includes an indication of the physical address associated with the access operation, the RAS module may determine that the row indicated by the physical address has been repaired, and may execute the access operation at the spare row associated with the field 415 storing the indication of the physical address.

As indicated above, FIG. 4 is provided as an example. Other examples may differ from what is described with regard to FIG. 4.

FIG. 5 is a flowchart of an example method 500 associated with memory system repair operations. In some implementations, a memory system (e.g., the memory system 300) may perform or may be configured to perform the method 500. The method 500 may correspond to a method for performing a repair operation on a defective row, as described herein.

At 510, the memory system 300 may determine to perform a repair operation on row 355 that is defective. In one example, the memory system 300 may determine to perform the repair operation on the row 355 in response to receiving a command from a host system. For example, a host system (such as the host system 105 or the CXL host 202) may provide, and the memory system 300 may receive, a Perform Maintenance Command. The Perform Maintenance Command may indicate an address (e.g., an address) that corresponds to a row 355 that is defective. The memory system controller 315 may identify, based on the indicated address, a physical address of the row 355 that is defective. For example, the memory system controller 315 may identify, based on a logical-to-physical mapping stored in the nonvolatile memory array 365 or the volatile memory array 335, that the Perform Maintenance Command includes an address corresponding to the row 355-b in memory bank 350-a. Here, the RAS module 310 may remap the address previously corresponding to the row 355-b to instead correspond to one of the spare rows 360.

In another example, the memory system 300 may determine to perform the repair operation on the row 355 in response to detecting that the row 355 is likely to become defective. For example, the error manager 305 may perform a scanning operation on the rows 355 in a memory bank 350. To perform the scanning operation, the error manager 305 may write a set of known pattern data to the rows 355 in the memory bank 350. Then, the error manager 305 may read the rows 355 in the memory bank 350 and detect differences between the set of known pattern data and the data read from the rows 355 in the memory bank 350. If, during the scanning operation, the error manager 305 determines that any of the rows 355 fails to satisfy a reliability threshold, the error manager 305 may determine to perform the repair operation on the row 355. In some cases, the reliability threshold may correspond to a threshold quantity of errors detected in the data read from the rows 355. In these cases, if the data read from a row 355 includes more than the threshold quantity of errors, the error manager 305 may determine to perform a repair operation on the row 355.

At 515, and in response to determining to perform the repair operation on a row 355, the RAS module 310 may transfer data from the row 355 to the buffer 330 in the RAS module 310. For example, to perform the repair operation on the row 355-f in the memory bank 350-b, the RAS module 310 may read the data from the row 355-f and store the data in the buffer 330.

At 520, the memory system 300 may optionally execute an access operation at the buffer 330. For example, if the memory system 300 receives or generates an access command associated with an address that corresponds to a row 355 that is defective prior to a completion of the execution of a repair operation of the row 355 that is defective, the memory system 300 may execute the corresponding access operation at the buffer 330. For example, the memory system may determine to perform the repair operation on the row 355-b (e.g., at 510) and transfer the data from the row 355-b to the buffer 330 (e.g., at 515). After transferring the data to the buffer 330 (and before completing the execution of the repair operation on the row 355-b), the memory system 300 may receive an access command indicating an address associated with the row 355-b. The memory system 300 may execute an access operation indicated by the access command at the buffer 330. That is, if the access operation is a read operation, the memory system 300 may read the data from the buffer 330. Additionally, if the access operation is a write operation, the memory system 300 may write the data associated with the write operation to the buffer 330. Therefore, the memory system 300 may continue to perform access operations associated with the address that corresponds to the row 355 that is defective while performing the repair operation on the row 355.

At 525, the RAS module 310 may remap an address corresponding to a row 355 that is defective in a memory bank 350 to one of the spare rows 360 in the same memory bank 350. For example, the RAS module 310 may store an indication of a physical address of the row 355 that is defective in a field of an address redirector included in the remapping circuitry 340 (such as the address redirector 405 described with reference to FIG. 4). The RAS module 310 may identify the physical address of the spare row 360 for the remapping based on the spare row 360 that is associated with the field of the address redirector that is storing the indication of the physical address of the row 355 that is defective.

At 530, the RAS module 310 may transfer the data from the buffer 330 to the spare row 360. In some cases, the RAS module 310 may use the remapping circuitry 340 to identify the physical address of the spare row 360. For example, the RAS module 310 may use the remapping circuitry 340 to for an address translation that translates the physical address of the row 355 that is defective to the physical address for the spare row 360 (e.g., as described with reference to FIG. 4). Then, the RAS module 310 may write the data stored in the buffer 330 to the spare row 360.

At 535, the RAS module 310 may store a physical address of the row 355 that is defective in the nonvolatile memory array 365. That is, nonvolatile memory array 365 may be storing a repair list including the set of physical addresses of the rows 355 that have been repaired. By writing the physical address of the rows 355 that are defective in the nonvolatile memory array 365, the repair operation of the defective rows may persist across power cycles. In particular, the memory system 300 may rely on the repair list stored in the nonvolatile memory array 365 to rebuild the address redirector associated with the remapping circuitry 340 as part of a in initialization operation, as described with reference to FIG. 7.

As indicated above, FIG. 5 is provided as an example. Other examples may differ from what is described with regard to FIG. 5.

FIG. 6 is a flowchart of an example method 600 associated with memory system repair operations. In some implementations, a memory system (e.g., the memory system 300) may perform or may be configured to perform the method 600. The method 600 may correspond to a method for performing an access operation at an address that may have been previously remapped from a defective row to a spare row, as described herein.

At 610, the memory system 300 may receive an access command (such as from a host system 105, from a CXL host 202) that indicates for an access operation to be performed at an address. In some cases, the access command may indicate for the memory system 300 to perform a read operation, a write operation, a refresh operation, or some other access operation.

At 615, the memory system 300 may identify a first physical address of a row 355 based on the address indicated by the access command. In some cases, the memory system 300 may include a logical-to-physical mapping table (e.g., at a volatile memory array 335, at a nonvolatile memory array 365) that indicates a mapping between an address space and a physical address space. Here, the memory system controller 315 may identify a physical address of a row 355 based on the logical-to-physical mapping (e.g., indicated by the logical-to-physical mapping table) between the address included in the access command and the physical address of the row 355.

At 620, the memory system 300 may optionally determine whether a memory bank 350 that includes the row 355 has any repaired rows 355. In particular, some memory systems 300 may include a bitmap (e.g., within the error manager 305, within the RAS module 310) that includes a set of bank-level indications. If the memory system 300 stores such a bitmap, the memory system 300 may determine whether the memory bank 350 that includes the row 355 has remapped the addresses associated with any defective rows to spare rows 360 based on the bitmap.

In particular, each bit of the bitmap may correspond to one of the memory banks 350 that are coupled to the RAS Module 310 (e.g., via the channel 345). If a bit in the bitmap has a first value (e.g., a value ‘0’), the bitmap may indicate that the corresponding memory bank 350 does not include any repaired rows. For example, if a bit in the bitmap that corresponds to the memory bank 350-a has the first value, the bitmap may indicate that the RAS module 310 has not performed a repair operation on any of the rows 355 in the memory bank 350-a and that, by extension, none of the addresses associated with any of the rows 355 in the memory bank 350-a have been remapped to the spare rows 360 in the memory bank 350-a. Additionally, if a bit in the bitmap has a second value (e.g., a value ‘1’), the bitmap may indicate that the corresponding memory bank 350 has one or more rows 355 that have been repaired. For example, if a bit in the bitmap that corresponds to the memory bank 350-b has the second value, the bitmap may indicate that the RAS module 310 has performed at least one repair operation on at least one of the rows 355 in the memory bank 350-b, and that, by extension, at least one of the addresses associated with the rows 355 in the memory bank 350-b have been remapped to a spare row 360 in the memory bank 350-b.

If the bitmap indicates that the memory bank 350 has at least one row 355 that has been repaired, the memory system 300 may proceed to 625. Additionally, if the bitmap indicates that the memory bank 350 does not have any rows 355 that have been repaired, the memory system 300 may proceed to 630. That is, if the bitmap indicates that the memory bank 350 does not have any rows 355 that have been repaired, the memory system 300 may avoid comparing the first physical address of the row 355 to the values stored in one or more fields of an address redirector in the remapping circuitry 340.

At 625, the memory system 300 may determine whether the address indicated by the access command has been remapped to a second physical address of a spare row. To determine whether the address has been remapped, the memory system controller 315 may read the set of fields in an address redirector (such as the address redirector 405 described with reference to FIG. 4) of the remapping circuitry 340 that are associated with the memory bank 350 that includes the row 355 having the first physical address. For example, if the first physical address is of the row 355-d, the memory system controller 315 may read the set of fields in the address redirector that are associated with the memory bank 350-b. In some cases, the memory system controller 315 may determine an offset (e.g., associated with the set of fields) in the address redirector for reading the set of fields based on the rank and the memory bank associated with the first physical address. The first physical address may be compared to each of the physical addresses indicated by the set of fields.

If any of the set of fields includes an indication of the first physical address, the memory system controller 315 may determine that the address indicated by the access command has been remapped to a second physical address, and may proceed to 635. That is, the memory system controller 315 may determine that the row 355 indicated by the first physical address has been repaired. Accordingly, the address associated with the row 355 (e.g., having the first physical address) has been remapped to a second physical address corresponding to one of the spare rows 360 in the memory bank 350. Here, the memory system controller 315 may identify the second physical address of the spare row 360 that corresponds to the address based on the field that includes the indication of the first physical address being associated with the spare row 360 that has the second physical address.

Additionally, if none of the set of fields include an indication of the first physical address, the memory system controller 315 may determine that the address indicated by the access command has not been remapped to a second physical address. That is, the memory system controller 315 may determine that the row 355 indicated by the first physical address has not been repaired.

At 630, the memory system 300 may execute the access operation at the row 355 that has the first physical address. That is, the memory system 300 may execute the access operation at the row 355 based on determining that the address associated with the row 355 has not been remapped (e.g., based on determining that the row 355 has not been repaired).

At 635, the memory system 300 may execute the access operation at the spare row 360 that has the second physical address. That is, the memory system 300 may execute the access operation at the spare row 360 based on determining that the address associated with the row 355 having the first physical address has been remapped (e.g., based on determining that the row 355 has been repaired).

As indicated above, FIG. 6 is provided as an example. Other examples may differ from what is described with regard to FIG. 6.

FIG. 7 is a flowchart of an example method 700 associated with memory system repair operations. In some implementations, a memory system (e.g., the memory system 300) may perform or may be configured to perform the method 700. The method 700 may correspond to a method for performing an initialization operation after performing a repair operation on a defective row in a memory bank, as described herein.

The memory system 300 may perform the initialization operation after being power cycled, during a system startup, as part of a firmware update, and in response to some errors or a system crash. As part of the initialization operation, the memory system 300 may rebuild an address redirector (such as the address redirector 405) that is part of the remapping circuitry 340. That is, the address redirector may not store data persistently across a power cycle. Accordingly, the memory system 300 may perform the method 700 to reestablish the data within the address redirector of the remapping circuitry 340. In some cases, the memory system 300 may execute the initialization operation during a time period that the memory system 300 is not receiving access commands (e.g., from a host system). For example, the memory system 300 may set a media ready bit to a first value (e.g., a ‘0’) that indicates that the memory system 300 is not ready to receive access commands. Upon completion of the initialization operation, the memory system 300 may set the media ready bit to a second value (e.g., a ‘1’) that indicates that the memory system 300 is ready to receive access commands. The memory system 300 may not complete an execution of the initialization operation until a time that occurs after a completion of the method 700.

At 705, the memory system controller 315 may transfer the physical addresses from the nonvolatile memory array 365 to the volatile memory array 335. For example, the memory system controller 315 may transfer a repair list file (e.g., that comprises the list of physical addresses of the rows 355 that have been repaired) from the nonvolatile memory array 365 (e.g., a NOR Flash memory array) to the volatile memory array 335 (e.g., to SRAM).

At 710, the memory system controller 315 may perform a scanning operation on the spare rows 360 in the memory banks 350 of the memory system 300. That is, the memory system controller 315 may check the health of the spare rows 360 in the memory banks 350. To perform the scanning operation, the memory system controller 315 may write a set of known data (e.g., pattern data) to the spare rows 360 and subsequently read data from the spare rows 360. The memory system controller 315 may detect errors in the read data if the data read from the spare rows 360 is different from the set of known data.

In some cases, the memory system controller 315 may determine whether each spare row 360 satisfies a reliability threshold (e.g., is healthy). For example, if the data stored by the spare row 360 (and read during the scanning operation) contains less than a threshold quantity of errors, the memory system controller 315 may determine that the spare row 360 satisfies the reliability threshold (e.g., and is healthy). Additionally, if the data stored by the spare row 360 (and read during the scanning operation) contains more than the threshold quantity of errors, the memory system controller 315 may determine that the spare row 360 fails to satisfy the reliability threshold (e.g., and is unhealthy or defective). If the memory system controller 315 determines that any of the spare rows 360 fail to satisfy the reliability threshold, the memory system controller 315 may proceed to 715. Additionally, if the memory system controller 315 determines that all of the spare rows 360 satisfy the reliability threshold, the memory system controller 315 may proceed to 720 (e.g., without executing the operations described with reference to 715).

At 715, the memory system controller 315 may optionally store an indication of the spare rows 360 that fail to satisfy the reliability threshold. In some cases, the memory system controller 315 may store the indication of a spare row 360 that fails to satisfy the reliability threshold in an address redirector (such as the address redirector 405) in the remapping circuitry 340. For example, the address redirector may include a field that is associated with the spare row 360, and the memory system controller 315 may store an indication that the spare row 360 fails to satisfy the reliability threshold in that field. In some cases, the memory system controller 315 may exclude any spare rows 360 that fail to satisfy the reliability threshold from repair operations. That is, the memory system controller 315 may not remap an address from a row 355 that is defective to any spare row 360 that fails to satisfy the reliability threshold.

At 720, the memory system controller 315 may identify a memory bank 350 associated with each of the physical addresses stored in the volatile memory array 335. The memory system controller 315 may identify the memory bank 350 based on the physical address. That is, the memory system controller 315 may identify a channel 345, a memory device 320, and/or a memory bank 350 associated with the physical address.

At 725, the memory system controller 315 may identify, for each of the physical addresses, whether the associated memory bank 350 includes a spare row 360 available to repair the row 355 that is defective corresponding to the physical address. In some cases, the memory bank 350 may include more defective rows than available spare rows 360. Additionally, or alternatively, one or more of the spare rows 360 that the memory system 300 previously relied upon to repair a row 355 that is defective may have failed to satisfy the reliability threshold, and may thus be excluded from repairing the row 355 that is defective. If the memory bank 350 does include a spare row 360 that is available to repair a row 355 that is defective, the memory system controller 315 may proceed to 730. Additionally, if the memory bank 350 does not include sufficient resources to repair the row 355 that is defective (e.g., if the memory bank 350 does not include a spare row 360 that is available to repair the row 355 that is defective), the memory system controller 315 may proceed to 735 or 740. In some cases, a firmware policy of the memory system 300 may dictate whether the memory system controller 315 proceeds to 735 or 740.

At 730, the memory system controller 315 may store an indication of a remapping of an address from the row 355 that is defective to the spare row 360. For example, the memory system controller 315 may store an indication of the physical address of the row 355 that is defective in a field of an address redirector in the remapping circuitry 340 that is associated with the spare row 360.

At 735, the memory system controller 315 may determine to store data associated with the row 355 that is defective at the buffer 330. Here, the memory system controller 315 may pin the one or more addresses associated with the row 355 that is defective to the buffer 330. Here, future access operations may be performed at the buffer 330, which may prevent access operations from being performed at the row 355 that is defective.

At 740, the memory system controller 315 may indicate, to a host system (such as to the host system 105 or the CXL host 202) that the address associated with the row 355 that is defective is faulty. For example, the memory system controller 315 may add the one or more addresses associated with the row 355 that is defective to a poison list. In some cases, adding the one or more addresses to the poison list may prevent any further data from being written to or read from the row 355 that is defective.

As indicated above, FIG. 7 is provided as an example. Other examples may differ from what is described with regard to FIG. 7.

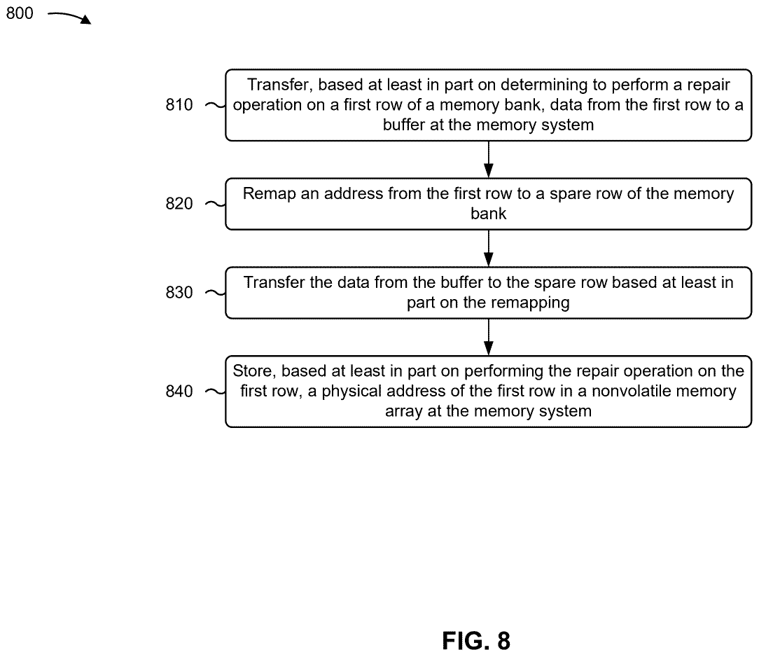

FIG. 8 is a flowchart of an example method 800 associated with memory system repair operations. In some implementations, a memory system (e.g., the memory system 110, the CXL compliant memory system 204, the memory system 300) may perform or may be configured to perform the method 800. In some implementations, another device or a group of devices separate from or including the memory system may perform or may be configured to perform the method 800. Additionally, or alternatively, one or more components of the memory system (e.g., the memory system controller 115, the local controllers 125, the I/O path hardware logic and DMA controller, the main management subsystem 214, the memory system controller 315, the controller 325, the error manager 305, the RAS module 310) may perform or may be configured to perform the method 800. Thus, means for performing the method 800 may include the memory system and/or one or more components of the memory system. Additionally, or alternatively, a non-transitory computer-readable medium may store one or more instructions that, when executed by the memory system, cause the memory system to perform the method 800.

As shown in FIG. 8, the method 800 may include transferring, based at least in part on determining to perform a repair operation on a first row of a memory bank, data from the first row to a buffer at the memory system (block 810). As further shown in FIG. 8, the method 800 may include remapping an address from the first row to a spare row of the memory bank (block 820). As further shown in FIG. 8, the method 800 may include transferring the data from the buffer to the spare row based at least in part on the remapping (block 830). As further shown in FIG. 8, the method 800 may include storing, based at least in part on performing the repair operation on the first row, a physical address of the first row in a nonvolatile memory array at the memory system (block 840).

The method 800 may include additional aspects, such as any single aspect or any combination of aspects described below and/or described in connection with one or more other methods or operations described elsewhere herein.

In a first aspect, the method 800 includes receiving, from a host system, an access command associated with the address, and executing the access command at the buffer based at least in part on receiving the access command after transferring the data to the buffer and prior to transferring the data to the spare row.

In a second aspect, alone or in combination with the first aspect, the method 800 includes storing an indication of the first row in a field of an address redirector at the memory system, wherein the field is associated with the spare row, and wherein the remapping is based at least in part on the indication of the first row being stored in the field associated with the spare row.

In a third aspect, alone or in combination with one or more of the first and second aspects, the field is further associated with the memory bank and a rank comprising the memory bank.

In a fourth aspect, alone or in combination with one or more of the first through third aspects, the method 800 includes identifying the spare row from a plurality of spare rows for the memory bank based at least in part on the field being associated with the spare row, wherein transferring the data from the buffer to the spare row is based at least in part on the identifying.

In a fifth aspect, alone or in combination with one or more of the first through fourth aspects, the method 800 includes receiving a command to perform the repair operation from a host system, wherein the transferring is based at least in part on the command.

In a sixth aspect, alone or in combination with one or more of the first through fifth aspects, the method 800 includes transferring, as part of an initialization operation at the memory system, the physical address stored in the nonvolatile memory array to a volatile memory array at the memory system; identifying the spare row that is available to store data associated with the address that previously corresponded to the first row, storing, in an address redirector at the memory system, an indication of the remapping of the address from the first row to the spare row; and completing an execution of the initialization operation after storing the indication of the remapping in the address redirector.

In a seventh aspect, alone or in combination with one or more of the first through sixth aspects, the method 800 includes initiating the repair operation based at least in part on detecting an event indicating a likelihood that the first row of the memory bank will become defective.

In an eighth aspect, alone or in combination with one or more of the first through seventh aspects, the nonvolatile memory array comprises NOR flash memory.

Although FIG. 8 shows example blocks of a method 800, in some implementations, the method 800 may include additional blocks, fewer blocks, different blocks, or differently arranged blocks than those depicted in FIG. 8. Additionally, or alternatively, two or more of the blocks of the method 800 may be performed in parallel. The method 800 is an example of one method that may be performed by one or more devices described herein. These one or more devices may perform or may be configured to perform one or more other methods based on operations described herein.

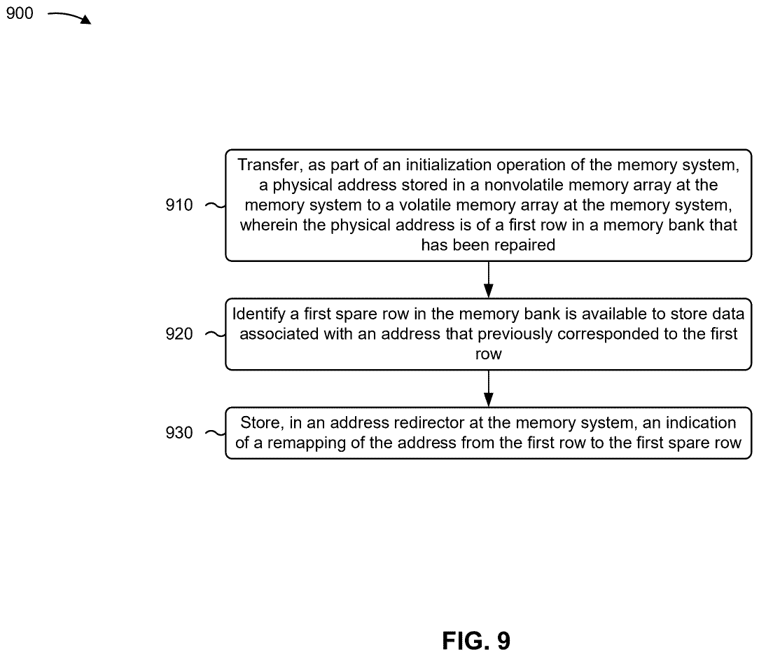

FIG. 9 is a flowchart of an example method 900 associated with memory system repair operations. In some implementations, a memory system (e.g., the memory system 110, the CXL compliant memory system 204, the memory system 300) may perform or may be configured to perform the method 900. In some implementations, another device or a group of devices separate from or including the memory system may perform or may be configured to perform the method 900. Additionally, or alternatively, one or more components of the memory system (e.g., the memory system controller 115, the local controllers 125, the I/O path hardware logic and DMA controller, the main management subsystem 214, the memory system controller 315, the controller 325, the error manager 305, the RAS module 310) may perform or may be configured to perform the method 900. Thus, means for performing the method 900 may include the memory system and/or one or more components of the memory system. Additionally, or alternatively, a non-transitory computer-readable medium may store one or more instructions that, when executed by the memory system, cause the memory system to perform the method 900.

As shown in FIG. 9, the method 900 may include transferring, as part of an initialization operation of the memory system, a physical address stored in a nonvolatile memory array at the memory system to a volatile memory array at the memory system, wherein the physical address is of a first row in a memory bank that has been repaired (block 910). As further shown in FIG. 9, the method 900 may include identifying a first spare row in the memory bank that is available to store data associated with an address that previously corresponded to the first row (block 920). As further shown in FIG. 9, the method 900 may include storing, in an address redirector at the memory system, an indication of a remapping of the address from the first row to the first spare row (block 930).

The method 900 may include additional aspects, such as any single aspect or any combination of aspects described below and/or described in connection with one or more other methods or operations described elsewhere herein.

In a first aspect, the method 900 includes performing a scanning operation on a plurality of spare rows in the memory bank to identify spare rows that fail to satisfy a reliability threshold, wherein storing the indication of the remapping is based at least in part on the first spare row satisfying the reliability threshold.

In a second aspect, alone or in combination with the first aspect, the method 900 includes storing, in the address redirector, an indication of the spare rows that fail to satisfy the reliability threshold, wherein the spare rows that fail to satisfy the reliability threshold are excluded from future repair operations at the memory bank.

In a third aspect, alone or in combination with one or more of the first and second aspects, storing the indication comprises storing the indication of the spare rows that fail to satisfy the reliability threshold in one or more fields of the address redirector that are associated with the spare rows that fail to satisfy the reliability threshold.

In a fourth aspect, alone or in combination with one or more of the first through third aspects, identifying the first spare row is based at least in part on a physical channel of the memory system associated with the physical address, one or more spare rows associated with the physical channel, or a combination thereof.

In a fifth aspect, alone or in combination with one or more of the first through fourth aspects, the method 900 includes identifying that the memory bank does not comprise a spare row for a second physical address stored in the nonvolatile memory array, wherein the second physical address is of a second row in the memory bank that has been repaired; and storing the data associated with a second address that previously corresponded to the second row in a buffer at the memory system.

In a sixth aspect, alone or in combination with one or more of the first through fifth aspects, the method 900 includes identifying that the memory bank does not comprise a spare row for a second physical address stored in the nonvolatile memory array, wherein the second physical address is of a second row in the memory bank that has been repaired; and indicating, to a host system, that a second address that previously corresponded to the second row is faulty.

In a seventh aspect, alone or in combination with one or more of the first through sixth aspects, the address redirector comprises a plurality of fields that are each associated with one of a plurality of spare rows, and storing the indication of the remapping comprises storing an indication of the physical address in a field of the address redirector associated with the first spare row.

In an eighth aspect, alone or in combination with one or more of the first through seventh aspects, the method 900 includes completing an execution of the initialization operation after storing the indication of the remapping in the address redirector.

Although FIG. 9 shows example blocks of a method 900, in some implementations, the method 900 may include additional blocks, fewer blocks, different blocks, or differently arranged blocks than those depicted in FIG. 9. Additionally, or alternatively, two or more of the blocks of the method 900 may be performed in parallel. The method 900 is an example of one method that may be performed by one or more devices described herein. These one or more devices may perform or may be configured to perform one or more other methods based on operations described herein.

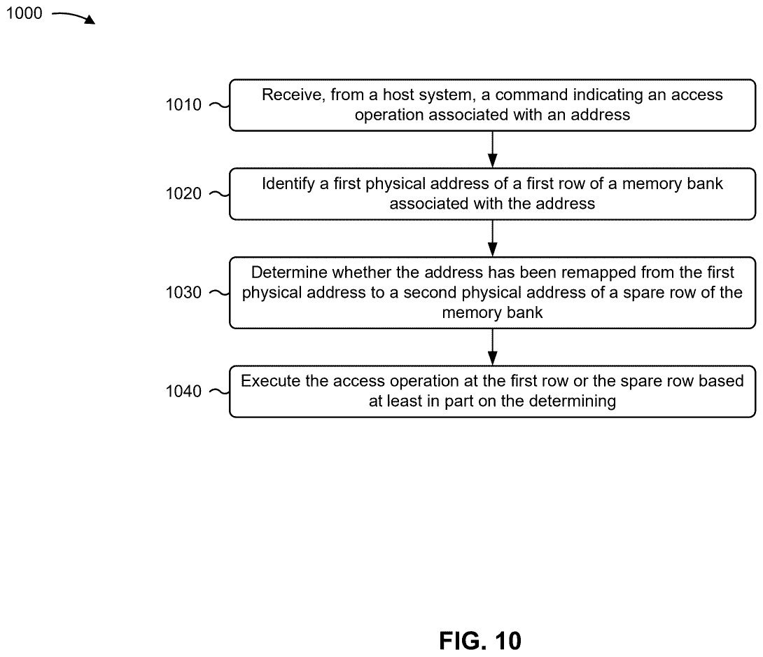

FIG. 10 is a flowchart of an example method 1000 associated with memory system repair operations. In some implementations, a memory system (e.g., the memory system 110, the CXL compliant memory system 204, the memory system 300) may perform or may be configured to perform the method 1000. In some implementations, another device or a group of devices separate from or including the memory system may perform or may be configured to perform the method 1000. Additionally, or alternatively, one or more components of the memory system (e.g., the memory system controller 115, the local controllers 125, the I/O path hardware logic and DMA controller, the main management subsystem 214, the memory system controller 315, the controller 325, the error manager 305, the RAS modules 310) may perform or may be configured to perform the method 1000. Thus, means for performing the method 1000 may include the memory system and/or one or more components of the memory system. Additionally, or alternatively, a non-transitory computer-readable medium may store one or more instructions that, when executed by the memory system, cause the memory system to perform the method 1000.

As shown in FIG. 10, the method 1000 may include receiving, from a host system, a command indicating an access operation associated with an address (block 1010). As further shown in FIG. 10, the method 1000 may include identifying a first physical address of a first row of a memory bank associated with the address (block 1020). As further shown in FIG. 10, the method 1000 may include determining whether the address has been remapped from the first physical address to a second physical address of a spare row of the memory bank (block 1030). As further shown in FIG. 10, the method 1000 may include executing the access operation at the first row or the spare row based at least in part on the determining (block 1040).

The method 1000 may include additional aspects, such as any single aspect or any combination of aspects described below and/or described in connection with one or more other methods or operations described elsewhere herein.

In a first aspect, the method 1000 includes comparing the first physical address of the first row to one or more fields of an address redirector at the memory system, wherein determining whether the address has been remapped is based at least in part on whether the one or more fields comprise an indication of the first physical address.

In a second aspect, alone or in combination with the first aspect, the method 1000 includes reading a bitmap at the memory system, wherein a first bit in the bitmap that is associated with the memory bank indicates that at least one row of the memory bank has been repaired using one of a plurality of spare rows of the memory bank, and wherein the comparing is based at least in part on the first bit indicating that at least one row of the memory bank has been repaired.

In a third aspect, alone or in combination with one or more of the first and second aspects, the method 1000 includes identifying a field of the address redirector storing the indication of the first physical address, wherein determining whether the address has been remapped comprises determining that the address has been remapped based at least in part on the field of the address redirector storing the indication of the first physical address.

In a fourth aspect, alone or in combination with one or more of the first through third aspects, the method 1000 includes identifying the second physical address of the spare row based at least in part on the field of the address redirector being associated with the second physical address, wherein executing the access operation comprises executing the access operation at the spare row based at least in part on identifying the second physical address of the spare row.

In a fifth aspect, alone or in combination with one or more of the first through fourth aspects, the method 1000 includes identifying that none of the one or more fields of the address redirector are storing the indication of the first physical address, wherein determining whether the address has been remapped comprises determining that the address has not been remapped based at least in part on none of the one or more fields of the address redirector storing the indication of the first physical address.

In a sixth aspect, alone or in combination with one or more of the first through fifth aspects, the one or more fields of the address redirector are each associated with a different spare row of the memory bank.

In a seventh aspect, alone or in combination with one or more of the first through sixth aspects, identifying the first physical address comprises identifying the first physical address based at least in part on a logical-to-physical mapping indicative of the address being mapped to the first physical address of the first row.

Although FIG. 10 shows example blocks of a method 1000, in some implementations, the method 1000 may include additional blocks, fewer blocks, different blocks, or differently arranged blocks than those depicted in FIG. 10. Additionally, or alternatively, two or more of the blocks of the method 1000 may be performed in parallel. The method 1000 is an example of one method that may be performed by one or more devices described herein. These one or more devices may perform or may be configured to perform one or more other methods based on operations described herein.

In some implementations, a memory system includes a memory bank comprising: a plurality of rows, and a spare row configured to replace a defective row from the plurality of rows in the memory bank; remapping circuitry coupled to the memory bank and configured to update a mapping of an address from the defective row to the spare row; and a nonvolatile memory array configured to store a physical address of the defective row based on the remapping circuitry updating the mapping of the address associated with the defective row.

In some implementations, a method performed by a memory system includes transferring, based at least in part on determining to perform a repair operation on a first row of a memory bank, data from the first row to a buffer at the memory system; remapping an address from the first row to a spare row of the memory bank; transferring the data from the buffer to the spare row based at least in part on the remapping; and storing, based at least in part on performing the repair operation on the first row, a physical address of the first row in a nonvolatile memory array at the memory system.

In some implementations, a method performed by a memory system includes transferring, as part of an initialization operation of the memory system, a physical address stored in a nonvolatile memory array at the memory system to a volatile memory array at the memory system, wherein the physical address is of a first row in a memory bank that has been repaired; identifying a first spare row in the memory bank that is available to store data associated with an address that previously corresponded to the first row; and storing, in an address redirector at the memory system, an indication of a remapping of the address from the first row to the first spare row.

In some implementations, a method performed by a memory system includes receiving, from a host system, a command indicating an access operation associated with an address; identifying a first physical address of a first row of a memory bank associated with the address; determining whether the address has been remapped from the first physical address to a second physical address of a spare row of the memory bank; and executing the access operation at the first row or the spare row based at least in part on the determining.

In some implementations, a memory system includes one or more components configured to: transfer, based at least in part on determining to perform a repair operation on a first row of a memory bank, data from the first row to a buffer at the memory system; remap an address from the first row to a spare row of the memory bank; transfer the data from the buffer to the spare row based at least in part on the remapping; and store, based at least in part on performing the repair operation on the first row, a physical address of the first row in a nonvolatile memory array at the memory system.

The foregoing disclosure provides illustration and description but is not intended to be exhaustive or to limit the implementations to the precise forms disclosed. Modifications and variations may be made in light of the above disclosure or may be acquired from practice of the implementations described herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of implementations described herein. Many of these features may be combined in ways not specifically recited in the claims and/or disclosed in the specification. For example, the disclosure includes each dependent claim in a claim set in combination with every other individual claim in that claim set and every combination of multiple claims in that claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

When “a component” or “one or more components” (or another element, such as “a controller” or “one or more controllers”) is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Where only one item is intended, the phrase “only one,” “single,” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. As used herein, the term “multiple” can be replaced with “a plurality of” and vice versa. Also, as used herein, the term “or” is intended to be inclusive when used in a series and may be used interchangeably with “and/or,” unless explicitly stated otherwise (e.g., if used in combination with “either” or “only one of”).

What is claimed is:

1. A memory system, comprising:
a memory bank, comprising:
a plurality of rows, and
a spare row configured to replace a defective row from the plurality of rows in the memory bank;
remapping circuitry coupled to the memory bank and configured to update a mapping of an address from the defective row to the spare row; and
a nonvolatile memory array configured to store a physical address of the defective row based on the remapping circuitry updating the mapping of the address associated with the defective row.

2. The memory system of claim 1, further comprising:
a buffer coupled to the remapping circuitry; and
a controller coupled to the buffer and configured to:
transfer data from the defective row to the buffer during a repair operation of the defective row; and
transfer the data from the buffer to the spare row during the repair operation.

3. The memory system of claim 2, wherein the controller is further configured to:
execute one or more access operations associated with the address at the buffer based at least in part on executing the access operation after transferring the data to the buffer and prior to transferring the data to the spare row.

4. The memory system of claim 1, wherein:
the remapping circuitry comprises address redirector;
the address redirector comprises a plurality of fields that are each associated with one of a plurality of spare rows in the memory bank; and
updating the mapping of the address comprises storing an indication of the physical address associated with the defective row in a field of the address redirector that is associated with the spare row.

5. The memory system of claim 1, further comprising:
a channel that couples the memory bank to the remapping circuitry, wherein the remapping circuitry is configured to update mappings of addresses from defective rows in the memory bank.

6. The memory system of claim 1, further comprising:
a controller coupled to the nonvolatile memory array and configured to:
transfer, as part of an initialization operation of the memory system, the physical address of the defective row from the nonvolatile memory array to a volatile memory array at the memory system;
identify the spare row that is available to store data associated with the address that previously corresponded to the defective row; and
store an indication of the updated mapping of the address from the defective row to the spare row in an address redirector at the memory system.

7. The memory system of claim 1, wherein the memory system is a compute express link (CXL) compliant memory system.

8. A method performed by a memory system, comprising:
transferring, based at least in part on determining to perform a repair operation on a first row of a memory bank, data from the first row to a buffer at the memory system;
remapping an address from the first row to a spare row of the memory bank;
transferring the data from the buffer to the spare row based at least in part on the remapping; and
storing, based at least in part on performing the repair operation on the first row, a physical address of the first row in a nonvolatile memory array at the memory system.

9. The method of claim 8, further comprising:
receiving, from a host system, an access command associated with the address; and
executing the access command at the buffer based at least in part on receiving the access command after transferring the data to the buffer and prior to transferring the data to the spare row.

10. The method of claim 8, further comprising:
storing an indication of the first row in a field of an address redirector at the memory system, wherein the field is associated with the spare row, and wherein the remapping is based at least in part on the indication of the first row being stored in the field associated with the spare row.

11. The method of claim 10, wherein the field is further associated with the memory bank and a rank comprising the memory bank.

12. The method of claim 10, further comprising:
identifying the spare row from a plurality of spare rows for the memory bank based at least in part on the field being associated with the spare row, wherein transferring the data from the buffer to the spare row is based at least in part on the identifying.

13. The method of claim 8, further comprising:
receiving a command to perform the repair operation from a host system, wherein the transferring is based at least in part on the command.

14. The method of claim 8, further comprising:
transferring, as part of an initialization operation at the memory system, the physical address stored in the nonvolatile memory array to a volatile memory array at the memory system;
identifying the spare row that is available to store data associated with the address that previously corresponded to the first row;
storing, in an address redirector at the memory system, an indication of the remapping of the address from the first row to the spare row; and
completing an execution of the initialization operation after storing the indication of the remapping in the address redirector.

15. The method of claim 8, further comprising:
initiating the repair operation based at least in part on detecting an event indicating a likelihood that the first row of the memory bank will become defective.

16. The method of claim 8, wherein the nonvolatile memory array comprises NOR flash memory.

17. A method performed by a memory system, comprising:
transferring, as part of an initialization operation of the memory system, a physical address stored in a nonvolatile memory array at the memory system to a volatile memory array at the memory system, wherein the physical address is of a first row in a memory bank that has been repaired;
identifying a first spare row in the memory bank that is available to store data associated with an address that previously corresponded to the first row; and
storing, in an address redirector at the memory system, an indication of a remapping of the address from the first row to the first spare row.

18. The method of claim 17, further comprising:
performing a scanning operation on a plurality of spare rows in the memory bank to identify spare rows that fail to satisfy a reliability threshold, wherein storing the indication of the remapping is based at least in part on the first spare row satisfying the reliability threshold.

19. The method of claim 18, further comprising:
storing, in the address redirector, an indication of the spare rows that fail to satisfy the reliability threshold, wherein the spare rows that fail to satisfy the reliability threshold are excluded from future repair operations at the memory bank.

20. The method of claim 19, wherein storing the indication comprises storing the indication of the spare rows that fail to satisfy the reliability threshold in one or more fields of the address redirector that are associated with the spare rows that fail to satisfy the reliability threshold.

21. The method of claim 17, wherein identifying the first spare row is based at least in part on a physical channel of the memory system associated with the physical address, one or more spare rows associated with the physical channel, or a combination thereof.

22. The method of claim 17, further comprising:
identifying that the memory bank does not comprise a spare row for a second physical address stored in the nonvolatile memory array, wherein the second physical address is of a second row in the memory bank that has been repaired; and
storing data associated with a second address that previously corresponded to the second row in a buffer at the memory system.

23. The method of claim 17, further comprising:
identifying that the memory bank does not comprise a spare row for a second physical address stored in the nonvolatile memory array, wherein the second physical address is of a second row in the memory bank that has been repaired; and
indicating, to a host system, that a second address that previously corresponded to the second row is faulty.

24. The method of claim 17, wherein the address redirector comprises a plurality of fields that are each associated with one of a plurality of spare rows, and wherein storing the indication of the remapping comprises storing an indication of the physical address in a field of the address redirector associated with the first spare row.

25. The method of claim 17, further comprising:
completing an execution of the initialization operation after storing the indication of the remapping in the address redirector.

26. A method performed by a memory system, comprising:
receiving, from a host system, a command indicating an access operation associated with an address;
identifying a first physical address of a first row of a memory bank associated with the address;
determining whether the address has been remapped from the first physical address to a second physical address of a spare row of the memory bank; and
executing the access operation at the first row or the spare row based at least in part on the determining.

27. The method of claim 26, further comprising:
comparing the first physical address of the first row to one or more fields of an address redirector at the memory system, wherein determining whether the address has been remapped is based at least in part on whether the one or more fields comprise an indication of the first physical address.

28. The method of claim 27, further comprising:
reading a bitmap at the memory system, wherein a first bit in the bitmap that is associated with the memory bank indicates that at least one row of the memory bank has been repaired using one of a plurality of spare rows of the memory bank, and wherein the comparing is based at least in part on the first bit indicating that at least one row of the memory bank has been repaired.

29. The method of claim 27, further comprising:
identifying a field of the address redirector storing the indication of the first physical address, wherein determining whether the address has been remapped comprises:
determining that the address has been remapped based at least in part on the field of the address redirector storing the indication of the first physical address.

30. The method of claim 29, further comprising:
identifying the second physical address of the spare row based at least in part on the field of the address redirector being associated with the second physical address, wherein executing the access operation comprises:
executing the access operation at the spare row based at least in part on identifying the second physical address of the spare row.

31. The method of claim 27, further comprising:
identifying that none of the one or more fields of the address redirector are storing the indication of the first physical address, wherein determining whether the address has been remapped comprises:
determining that the address has not been remapped based at least in part on none of the one or more fields of the address redirector storing the indication of the first physical address.

32. The method of claim 27, wherein the one or more fields of the address redirector are each associated with a different spare row of the memory bank.

33. The method of claim 26, wherein identifying the first physical address comprises:
identifying the first physical address based at least in part on a logical-to-physical mapping indicative of the address being mapped to the first physical address of the first row.

34. A memory system, comprising:
one or more components configured to:
transfer, based at least in part on determining to perform a repair operation on a first row of a memory bank, data from the first row to a buffer at the memory system;
remap an address from the first row to a spare row of the memory bank;
transfer the data from the buffer to the spare row based at least in part on the remapping; and
store, based at least in part on performing the repair operation on the first row, a physical address of the first row in a nonvolatile memory array at the memory system.
